(19) United States
(12) Patent Application Publication
(10) Pub. No.: US 2021/0086461 A1
(43) Pub. Date: Mar. 25, 2021

(54) KEYHOLE SIPE BLADE

(71) Applicant: Bridgestone Americas Tire Operations, LLC, Nashville, TN (US)

(72) Inventor: Joseph A. Labbe, Jr., Silver Lake, OH (US)

(73) Assignee: Bridgestone Americas Tire Operations, LLC, Nashville, TN (US)

(21) Appl. No.: 16/071,109

(22) PCT Filed: Jan. 9, 2017
(86) PCT No.: PCT/US2017/012681

§ 371 Date: Jul. 19, 2018

Related U.S. Application Data
(60) Provisional application No. 62/281,477, filed on Jan. 21, 2016.

(51) Int. Cl. B29D 30/06; B60C 11/12

(52) U.S. Cl. CPC B29D 30/0606; B29D 2030/0613; B29D 2030/061; B60C 11/12

(57) ABSTRACT

Provided is a sipe blade for molding a cavity in a tire tread. The sipe blade may comprise an elongated bulb core having an axis of elongation and a peripheral surface and an elongated thin strap. The elongated thin strap may have a first end fixedly mounted to an associated tire tread mold surface, a second end opposite the first end, and may extending substantially normally to the associated tire tread mold surface. The first end and the second end may be connected by a first face. A bulb may be formed from the first face wrapped over the peripheral surface starting from the second end.

### I. BACKGROUND

### A. Technical Field

The present subject matter is directed to molding a cavity in a tire tread. More specifically, the present subject matter is directed to a sipe blade and a method of forming the sipe blade, where the sipe blade is adapted for molding a keyhole sipe in a tire tread.

### B. Description of Related Art

Formation of keyhole sipes in a tire tread is desirable. One way to form keyhole sipes in a tire is through inclusion of counterpart keyhole sipe blades in a tire mold used to form the tire. A keyhole sipe blade may comprise a bulb at the base of the blade corresponding to the keyhole region of the sipe to be formed thereby.

It remains desirable to provide improvements in keyhole sipe blades.

### II. SUMMARY

Provided is a sipe blade for molding a cavity in a tire tread. The sipe blade may comprise an elongated bulb core having an axis of elongation and a peripheral surface and an elongated thin strap. The elongated thin strap may have a first end fixedly mounted to an associated tire tread mold surface, a second end opposite the first end, and may extending substantially normally to the associated tire tread mold surface. The first end and the second end may be connected by a first face. A bulb may be formed from the first face wrapped over the peripheral surface starting from the second end.

Provided is a method of forming a sipe blade. The method may comprise providing an elongated bulb core, providing an elongated thin strap, and wrapping the first face over the peripheral surface starting from the second end to form a bulb. The elongated bulb core may have an axis of elongation, and a peripheral surface. The elongated thin strap may have a first end and a second end opposite the first end, wherein the first end is fixedly mountable to an associated tire tread mold surface in such a way that the second end extends substantially normally to the associated tire tread mold surface, and the first end and the second end are connected by a first face.

Provided is a sipe blade for molding a cavity in a tire tread. The sipe blade may comprise an elongated bulb core having an axis of elongation, a peripheral surface, and an elongated thin strap. The elongated thin strap may have a first end fixedly mounted to an associated tire tread mold surface, and a second end opposite the first end, wherein the first end and the second end are connected by a first face where the first face defines a first plane. A bulb may be formed from the first face wrapped over the peripheral surface starting from the second end.

### III. BRIEF DESCRIPTION OF THE DRAWINGS

FIG. 1 is a drawing of one embodiment of a keyhole sipe blade.

FIG. 2 is a drawing of one embodiment of a portion of a sipe blade engaged with one embodiment of a portion of an associated surface of a portion of an associated tire tread.

### IV. DETAILED DESCRIPTION

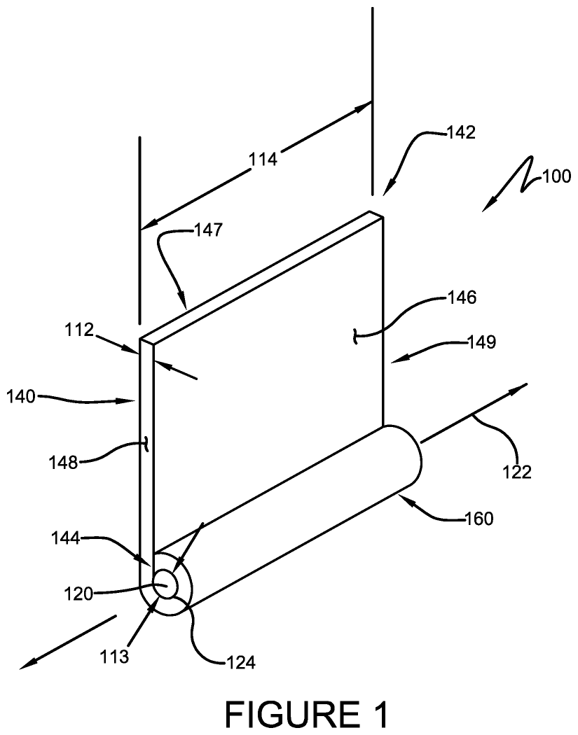

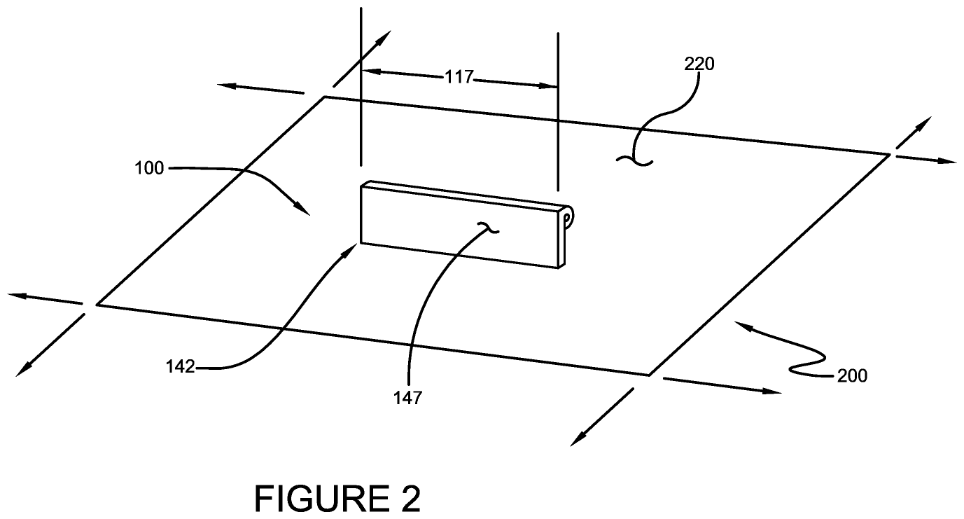

Referring now to FIGS. 1 and 2, provided is one non-limiting embodiment of a blade, a keyhole sipe blade 100, adapted for molding a cavity in a tire tread.

The keyhole sipe blade 100 may comprise an elongated bulb core 120 and an elongated thin strap 140, and a bulb 160. Without limitation, the keyhole sipe blade 100 may be engaged with an associated surface 220 of an associated tire tread mold 200 as described below.

The elongated bulb core 120 may comprise an axis of elongation 122, and a peripheral surface 124. The elongated bulb 120 core may have some width 117. The elongated bulb core 120 may be, without limitation, cylindrical. In some embodiments, the elongated bulb core 120 may be, without limitation, a circular cylinder, an elliptical cylinder, a triangular prism, square prism, rectangular prism, an n-sided prism, where n could be 3, 4, 5, 6, 7, 8, 9, 10, 20, 50, 100 or more. In some embodiments, the elongated bulb core 120 may have an cross-section normal to the elongation 122 such as a tear-drop shape, oval, an n-sided Reuleaux polygon where n could be 3, 4, 5, 6, 7, 8, 9, 10, 20, 50, 100 or more, a Reuleaux triangle, or otherwise. In embodiments in which the elongated bulb core 120 is substantially cylindrical, the elongated bulb core 120 will have some diameter 113. Without limitation, in some embodiments, diameter 113 may be 5 millimeters or less. Without limitation, in some embodiments diameter 113 may be 3 millimeters or less. In embodiments in which the elongated bulb core 120 is substantially cylindrical, the peripheral surface will have a surface area (not shown) defined by the width 117 and the diameter 113 where the surface area (not shown) is equal to the product of Pi, the width 117, and the diameter 113. The elongated bulb core 120 may be, without limitation, a rod or wire.

The elongated thin strap 140 may comprise a first end 142 fixedly mounted to an associated tire tread mold surface 220, having a second end 144 opposite the first end 142, and extending substantially normally to the associated tire tread mold surface 220, and wherein the first end 142 and the second end 144 are connected by a first face 146. The first end 142 and the second end 144 may also be connected by a second face 147 opposite the first face 146 where the second face 147 is offset from the first face 146 by the thickness 112 of the keyhole sipe blade 100. In some embodiments, the second face 147 may offset from the first face 146 by 2 millimeters or less. The first face 146 and second face 147 may also be connected by a first side 148 and a second side 149 opposite the first side 148, where the second side 149 is offset from the first side 148 by the width 114 of the keyhole sipe blade 100. The width 114 of the blade and the width 117 of the elongated bulb core may be, but are not necessarily, equal. It should be understood that the keyhole sipe blade 100 will have some length (not shown).

In some embodiments the elongated thin strap 140 may comprise a first end 142 fixedly mounted to an associated tire tread mold surface 220, having a second end 144 opposite the first end 142, wherein the first end 142 and the second end 144 are connected by a first face 142, the first face 142 defines a first plane coincident therewith. The first end 142 and the second end 144 may also be connected by a second face 147 opposite the first face 146 where the second face 147 is offset from the first face 146 by the thickness 112 of the keyhole sipe blade 100. The first face 146 and second face 147 may also be connected by a first side 148 and a second side 149 opposite the first side 148, where the second side 149 is offset from the first side 148 by the width 114 of the keyhole sipe blade 100. The width 114 of the blade and the width 117 of the elongated bulb core may be, but are not necessarily, equal. It should be understood that the keyhole sipe blade 100 will have some length (not shown). In some embodiments, the first plane is normal to the associated tire tread mold surface 220. In some embodiments, the first plane is coincident with the peripheral surface 124. In some embodiments, the axis of elongation 122 is parallel to the first plane. In some embodiments, the first plane is perpendicular to a plane tangent to the associated tire tread mold surface 220 at the first end 142. In some embodiments, the axis of elongation 122 is offset from the first plane by less than 1.5 millimeters. In some embodiments, the second face 147 may be opposite the first face and offset therefrom by 2 millimeters or less.

The bulb 160 may be formed a bulb 160 formed from the first face 146 wrapped over the peripheral surface 124 starting from the second end 144. In some embodiments, the peripheral surface 124 is in direct contact with the first face 146. It is to be understood that in some non-limiting embodiments one or more optional intermediate materials (not shown) may be sandwiched between the peripheral surface 124 and the first face 146 such that, at least in some regions, the peripheral surface 124 is separated from direct contact with the first face 146 by the one or more optional intermediate materials (not shown).

In some embodiments the peripheral surface 124 of the elongated bulb core 120 may have some surface features such as knurling, ribs, flutes, or otherwise. These surface features may promote positive engagement between the elongated bulb core 120 and the first face 146 or other material in contact with the peripheral surface 124.

The keyhole sipe blade 100 may be engaged with an associated surface 220 of an associated tire tread mold 200 by any means chosen with good engineering judgment. In some embodiments, the keyhole sipe blade 100 may be fixedly engaged with or fixedly mounted to an associated surface 220 of an associated tire tread mold 200 by welding, brazing, clamping, mechanical fasteners, casting around them, or other methods.

While the keyhole sipe blade 100 and associated method of forming have been described above in connection with various illustrative embodiments, it is to be understood that other similar embodiments may be used or modifications and additions may be made to the described embodiments for performing the same function disclosed herein without deviating therefrom. Further, all embodiments disclosed are not necessarily in the alternative, as various embodiments may be combined or subtracted to provide the desired characteristics. Variations can be made by one having ordinary skill in the art without departing from the spirit and scope hereof. Therefore, the keyhole sipe blade 100 and associated methods of forming should not be limited to any single embodiment, but rather construed in breadth and scope in accordance with the recitations of the appended claims. The right to claim elements and/or sub-combinations that are disclosed herein as other inventions in other patent documents is hereby unconditionally reserved.

Having thus described the disclosed keyhole sipe blade 100 and method, it is now claimed:

What is claimed is:

1. A sipe blade for molding a cavity in a tire tread, the sipe blade comprising:
an elongated bulb core having
an axis of elongation, and
a peripheral surface;
an elongated thin strap,
having a first end fixedly mounted to an associated tire tread mold surface,
having a second end
opposite the first end, and
extending substantially normally to the associated tire tread mold surface, and
wherein the first end and the second end are connected by a first face; and
a bulb formed from the first face wrapped over the peripheral surface starting from the second end.

2. The sipe blade for molding a cavity in a tire tread of claim 1, further comprising a second face opposite the first face and offset therefrom to define a blade thickness of 2 millimeters or less.

3. The sipe blade for molding a cavity in a tire tread of claim 2, wherein the elongated bulb core is cylindrical.

4. The sipe blade for molding a cavity in a tire tread of claim 3, wherein the elongated bulb core has a diameter of 3 millimeters or less.

5. The sipe blade for molding a cavity in a tire tread of claim 5, wherein the peripheral surface is in direct contact with the first face.

6. A method of forming a sipe blade comprising:
providing an elongated bulb core having
an axis of elongation, and
a peripheral surface;
providing an elongated thin strap,
having a first end
having a second end opposite the first end, and
wherein
the first end is fixedly mountable to an associated tire tread mold surface in such a way that the second end extends substantially normally to the associated tire tread mold surface, and
the first end and the second end are connected by a first face; and
wrapping the first face over the peripheral surface starting from the second end to form a bulb.

7. The method of forming a sipe blade of claim 6, further comprising mounting the first end fixedly to an associated tire tread mold surface.

8. The method of forming a sipe blade of claim 7, wherein the thin strap has a second face opposite the first face and offset therefrom to define a blade thickness of 2 millimeters or less.

9. The method of forming a sipe blade of claim 8, wherein the elongated bulb core is cylindrical.

10. The method of forming a sipe blade of claim 9, wherein the elongated bulb core has a diameter of 3 millimeters or less.

11. The method of forming a sipe blade of claim 10, wherein the peripheral surface is in direct contact with the first face.

12. A sipe blade for molding a cavity in a tire tread, the sipe blade comprising:
an elongated bulb core having
an axis of elongation, and
a peripheral surface;
an elongated thin strap,
having a first end fixedly mounted to an associated tire tread mold surface having a second end opposite the first end, and
wherein the first end and the second end are connected by a first face, the first face defining a first plane; and
a bulb formed from the first face wrapped over the peripheral surface starting from the second end.

13. The sipe blade for molding a cavity in a tire tread of claim 12, wherein the first plane is normal to the associated tire tread mold surface.

14. The sipe blade for molding a cavity in a tire tread of claim 12, wherein the first plane is coincident with the peripheral surface.

15. The sipe blade for molding a cavity in a tire tread of claim 12, wherein the axis of elongation is parallel to the first plane.

16. The sipe blade for molding a cavity in a tire tread of claim 15, wherein the first plane is perpendicular to a plane tangent to the associated tire tread mold surface at the first end.

17. The sipe blade for molding a cavity in a tire tread of claim 16, wherein the axis of elongation is offset from the first plane by less than 1.5 millimeters.

18. The sipe blade for molding a cavity in a tire tread of claim 17, further comprising a second face opposite the first face and offset therefrom by 2 millimeters or less.

19. The sipe blade for molding a cavity in a tire tread of claim 18, wherein the elongated bulb core is cylindrical.

20. The sipe blade for molding a cavity in a tire tread of claim 19, wherein the peripheral surface is in direct contact with the first face.
